(19) United States
(12) Patent Application Publication
(10) Pub. No.: US 2006/0105310 A1
(43) Pub. Date: May 18, 2006

(54) Infant speech and language development chair

(76) Inventor: Sheila Ann Mullin, Weston, FL (US)

Correspondence Address: Sheila Ann Mullin, 1040 Spyglass, Weston, FL, 33326, US

(21) Appl. No.: 10/998,116

(22) Filed: Nov. 27, 2004

Related U.S. Application Data
(60) Provisional application No. 60/627,548, filed on Nov. 12, 2004.

(51) Int. Cl. G09B 5/00

(52) U.S. Cl. 434/307 R

(57) ABSTRACT

There are many baby safe chairs on the market today. However, what is new in the art to which my invention pertains is the video monitor attached anterior to the chair which exhibits and verbally labels realistic pictures of common objects. It is similar to flashcards but requires no parent interaction. Parents can place their child in this safe and educational chair while performing household activities. This invention provides children with opportunity to learn and develop early speech and language skills through repetition while relaxing comfortably in a child safe chair. There are no other baby safe chairs that provide this function. This child safe chair is unique in that it houses a computerized speech teacher which will assist children to speak at the earliest age possible.

### CROSS-REFERENCE TO RELATED APPLICATIONS

60/627548-Original provisional application for this invention.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF INVENTION

The inventor of this utility is a Licensed Speech-Language Pathologist. Therefore, the Inventor has a thorough understanding of speech and language development. Children learn speech and language through human interaction, television, books, labeling of objects and repetition. Children first learn words receptively and then will later begin to utilize the learned words expressively. Many children in the United States today are speech and language delayed. There are many known and unknown reasons why some children are delayed while others are not. This fact along with the inventor's experience prompted the idea for this invention. There are no other products on the market today like this. This invention will assist parents in exposing children as early as possible to speech and language.

### BRIEF SUMMARY OF INVENTION

In summary, the present invention is a speech and language infant safety chair that enables infants 0-16 months to learn vocabulary words both receptively and expressively through viewing realistic pictures presented on a video monitor attached to the front of a chair. The pictures will be aligned in the child's visual field while hearing a realistic voice say the words through speakers built into the anterior portion of the monitor. The child will learn speech and language skills while relaxing comfortably in a safe chair. It is similar to flash cards, but parent participation is not necessary, only if desired. Most parents of infants own a “bouncy chair” and place their child in one because they know it is safe while they perform necessary household activities. However, this chair is unlike others because it will develop a child's speech and language skills while also providing safe and comfortable place to be.

### BRIEF DESCRIPTION OF THE SEVERAL VIEWS OF THE DRAWING

FIG. 1 is a slightly angled anterior view of the baby speech and language chair and a posterior view of the monitor.

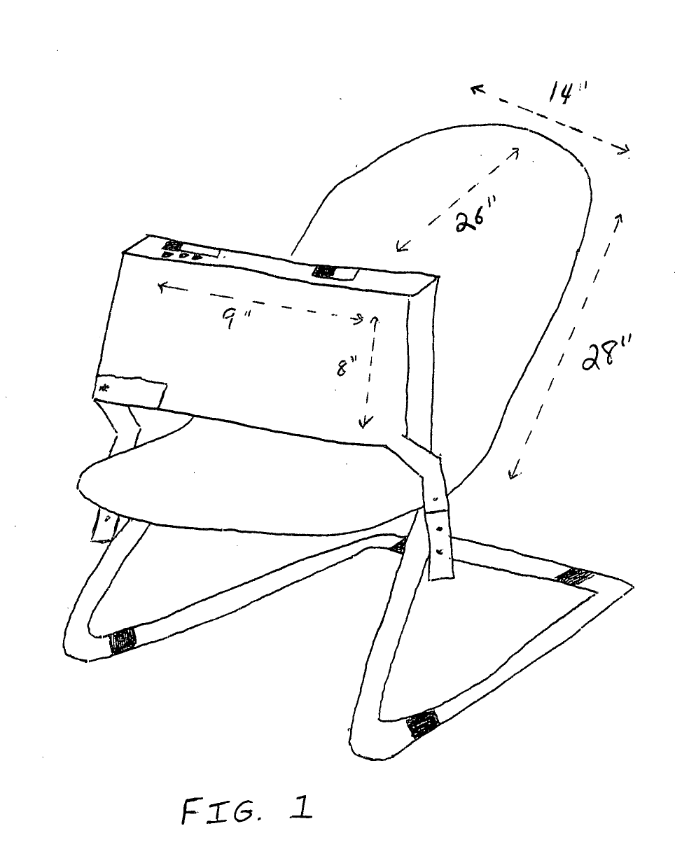

FIG. 2 is a side view of the baby speech and language chair and monitor.

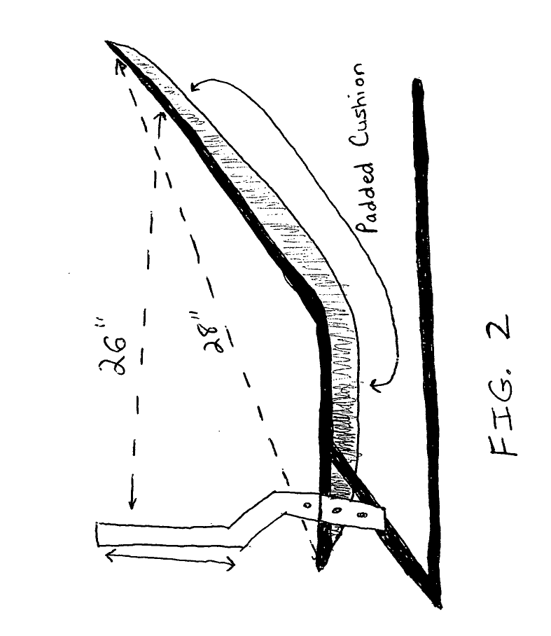

FIG. 3 is an anterior view of the monitor that will be attached to the chair.

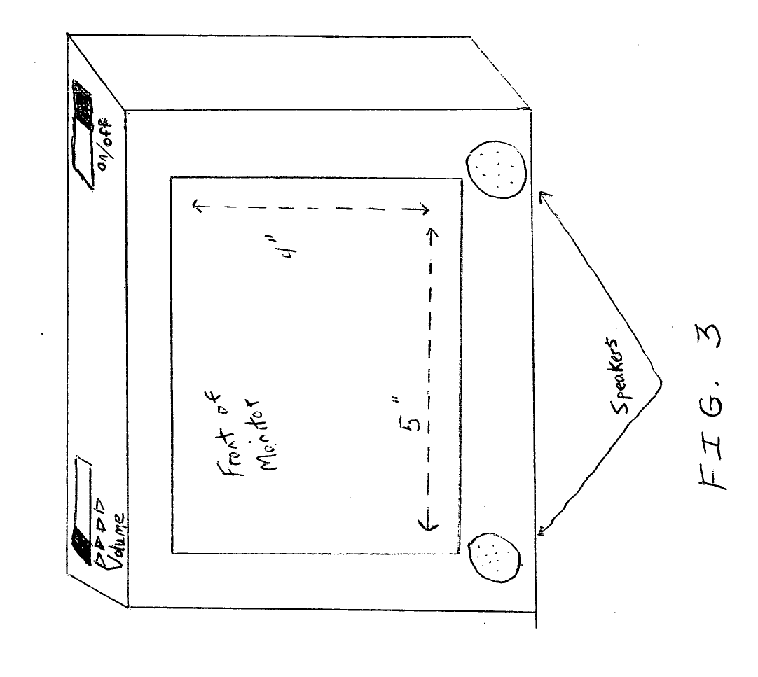

### DETAILED DESCRIPTION OF THE INVENTION

A reclined baby safety chair that has an adjustable screen attached to the front of the chair that is aligned to the baby's visual field. The screen will repeatedly exhibit and verbally label pictures of common objects to increase a baby's speech and language skills. This utility will increase a baby's expressive and receptive language skills through repetition of visual and auditory sensory modes. The baby will see a colored picture appear on a screen and a computer generated realistic voice will label the picture. For example, a picture of an apple will appear on the screen and then a voice will label this picture “Apple” wait a moment and then repeat itself It is similar to flashcards, but parents do not have to participate unless desired. There will be a sequence of categorized pictures that will repeat themselves a certain amount of times and then change categories (i.e. food, drinks, body parts, animals, transportation, clothes, toys, colors, utensils, furniture, weather, etc.). For example, the category of food would include items such as “apple”, “banana”, “cookie”, “cracker”, “cheerios”, etc. The drink category would include items such as “milk”, “water”, “juice” etc. The body part category would include items such as “eyes”, “nose”, “ears”, “mouth”, “teeth”, “hands”, “feet” etc. The categories will target babies first words. Children learn through repetition and the idea is for the baby to retain this information and eventually carry it over to their real life activities. This includes being able to receptively and expressively identify actual items during their daily routines. The pictures will be colorful to keep the baby's attention and the voice labeling the pictures will be soothing. There are many baby safety chairs on the market. However, this chair differs from others by its function which is to independently increase early speech and language skills in children. The baby will sit comfortably in a cushioned reclined baby safety chair, while learning and developing his or her speech and language skills It is by no means the chair that is novel, it is the function that teaches children early speech and language skills with no parent interaction while being comfortable in a safe and secure chair. It is a parent speech assistant and a computerized speech teacher for babies.

The chair frame will be made of metal. The frame will be approximately 14 inches wide and 28 inches long. The seat portion of the chair will be cushioned with fabric and padding to ensure comfort. The frame of the chair will house two adjustable brackets on each side of the anterior portion of the chair. These brackets will support the video monitor. The video monitor will be approximately 9 inches wide and 8 inches high. The monitor will house a screen for pictures that will be approximately 5 inches wide and 4 inches high The video monitor will have two speakers on the right and left side below the screen. The volume control and on/off switch will be housed on top portion of the monitor frame.

Having described the invention in detail and by reference to the preferred embodiments, it will be apparent that modifications and variations thereof are possible without departing from the scope of the invention. In addition, this invention can be made and sold in multiple languages.

1-6. (canceled)

7. This utility will teach infants speech and language skills with no parent interaction.

8. A baby safe chair that will assist parents in promoting early speech and language skills in children by increasing receptive and expressive vocabulary skills through visual and auditory sensory modes (i.e. seeing objects and hearing their labels).

9. This educational chair will assist children to speak at the earliest age possible through repetition of pictures and verbal labels. (i.e. Children will eventually recognize the object and remember the label all while relaxing comfortably in a child safe chair).
